(19) United States
(12) Patent Application Publication
(10) Pub. No.: US 2011/0148274 A1
(43) Pub. Date: Jun. 23, 2011

(54) Spark Plug for a Gas-Operated Internal Combustion Engine

(76) Inventors: Anko Ernst, Salem (DE); Udo Sander, Salem (DE); Mario Dittmann, Friedrichshafen (DE); Werner Niessner, Steinheim (DE); Alexander Schenk, Waiblingen (DE)

(21) Appl. No.: 12/969,245

(22) Filed: Dec. 15, 2010

(30) Foreign Application Priority Data
Dec. 18, 2009 (DE) 10 2009 060 110.4
Jan. 16, 2010 (DE) 10 2010 004 851.8

(51) Int. Cl. H01T 13/20

(52) U.S. Cl. 313/141

(57) ABSTRACT

The invention relates to a spark plug for a gas-fired internal combustion engine, and Includes a metallic body, with an insulator fastened in the body. A central electrode, leads through the insulator and includes a protruding end of a precious metal alloy. An annular ground electrode is fastened to the body and surrounds the end of the central electrode which, at the inside thereof facing the central electrode is provided with a precious metal or with a precious metal alloy. The mutually facing surfaces of the central electrode and ground electrode formed by the precious metal or the precious metal alloy are coaxially disposed cylinder surfaces. A cap is provided and attached to the body and which, after installation of the spark plug into a combustion chamber of the internal combustion engine, shields the central electrode and the ground electrode from the combustion chamber. Together with the body of the spark plug, the central electrode forms an ante-chamber, in which the central electrode and the ground electrode are disposed. The cap having at least one opening, which enables a gas exchange between the ante-chamber and the space outside of the ante-chamber. According to the invention, a deviation of the cylinder surfaces from the ideal cylinder geometry is less than +−20 μm, and a deviation of the positions of the axes of the cylinder surfaces from their ideal coaxial position is less than +−50 μm.

The invention relates to a spark plug for a gas-fired internal combustion engine, comprising a metallic body, an insulator fastened in the body, a central electrode, which leads through the insulator and which, at the end thereof protruding over the insulator, is provided with a precious metal or with a precious metal alloy, an annular ground electrode, which is fastened to the body, surrounds the end of the central electrode provided with a precious metal or with the precious metal alloy, and which, at the inside thereof facing the central electrode, is provided with a precious metal or with a precious metal alloy, the mutually facing surfaces of the central electrode and ground electrode formed by the precious metal or the precious metal alloy being coaxially disposed cylinder surfaces, and comprising a cap, which is attached to the body and which, after installation of the spark plug into a combustion chamber of the internal combustion engine, shields the central electrode and the ground electrode from the combustion chamber and, together with the body of the spark plug, forms an ante-chamber, in which the central electrode and the ground electrode are disposed, the cap having at least one opening, which enables a gas exchange between the ante-chamber and the space outside of the ante-chamber. Such a spark plug is disclosed in DE 101 44 976 A1.

In this spark plug, the central electrode and the ground electrode do not protrude directly into the combustion chamber of the internal combustion engine, but into an ante-chamber configured at the front of the spark plug, the ante-chamber being connected to the combustion chamber of the internal combustion engine by one or more openings, by which a gas exchange is possible between the ante-chamber and the combustion chamber.

Such spark plugs, which are also referred to as pre-chamber spark plugs, are used for igniting lean fuel-air mixtures in stationary, gas-operated internal combustion engines. A lean fuel-air mixture exists when the lambda ratio of the air volume actually present in the combustion chamber to the air volume stoichiometrically required for complete combustion of the fuel is greater than 1, with lambda values of 1.3 to 1.8, and particularly of lambda=1.6 to 1.7 being desirable. During the compression stroke of the internal combustion engine, an ignitable mixture is introduced into the ante-chamber through the openings of the ante-chamber. The ante-chamber, according to the function thereof, is a precombustion chamber. The ignitable gas-air mixture flowing into the ante-chamber is ignited, initially in the ante-chamber, by an ignition spark generated between the central electrode and the ground electrode. The flame generated in the ante-chamber is thrown out of the ante-chamber due to the pressure of the combustion developing in the ante-chamber, through the openings of the ante-chamber, and ignites the lean fuel-air mixture present in the combustion chamber of the internal combustion engine outside of the ante-chamber.

The electrodes of a spark plug are subject to burn-off, which limits the service lives thereof. As a result of the burn-off, the distance between the electrodes of the spark plug increases. Spark plugs without ante-chamber have the possibility to readjust the electrode gap, thereby compensating for the burn-off. This possibility does not exist with spark plugs having ante-chambers. For this reason, the pre-chamber spark plugs are subject to the requirement of achieving the longest possible service life. It is thus also known from DE 101 44 976 A1 to produce the electrodes from platinum, a platinum alloy, iridium, or an iridium alloy, or to tip them therewith.

It is the object of the present invention to provide a further measure, which is suited to increase the service life of a pre-chamber spark plug.

### SUMMARY OF THE INVENTION

The spark plug according to the invention comprises
a metallic body,
an insulator fastened in the body
a central electrode, which leads through the insulator and which, at the end thereof protruding over the insulator, is tipped with a precious metal or with a precious metal alloy,
an annular ground electrode, which is fastened to the body, surrounds the end of the central electrode provided with the precious metal or with the precious metal alloy, and which, at the inside thereof facing the central electrode, is provided with a precious metal or with a precious metal alloy, wherein the mutually facing surfaces of the central electrode and the ground electrode formed by the precious metal, or by the precious metal alloy, are coaxially disposed cylinder surface, and
a cap, which is attached to the body and which, after the installation of the spark plug in an internal combustion engine, shields the central electrode and the ground electrode from the combustion chamber and, together with the body of the spark plug, forms an ante-chamber, wherein the cap has at least one opening, which enables a gas exchange between the ante-chamber and the space outside of the ante-chamber;
the deviation of the cylinder surfaces from the ideal cylinder geometry being less than +−20 μm and the deviation of the positions of the axes of the cylinder surfaces from the ideal coaxial position being less than +−50 μm.

The deviation of the width of the annular gap, measured in the radial direction, between the mutually opposing cylinder surfaces from a predetermined clearance is preferably less than +−75 μm. It has been shown that the service life an a pre-chamber spark plug can be extended to an unexpected and surprising degree by ensuring that the deviation of the mutually opposing cylinder surfaces, which are formed by the precious metal or a precious metal alloy, from the ideal cylinder geometry, and the deviation from the ideal coaxial position, remains below the claimed threshold values. This causes the roots of the ignition sparks to be distributed considerably more uniformly over the cylindrical electrode surfaces, which are made of a precious metal or of a precious metal alloy, than in the prior art, so that the electrode surfaces burn off more uniformly, and practically the entire electrode surfaces are available for burn-off. It is a particular advantage of the invention that this also applies when the electrode surfaces are increased as compared to the electrode surfaces of known pre-chamber spark plugs, whereby the amount of electrode material available for the inevitable burn-off can be increased even further. Preferably the size of the cylinder surface of the central electrode formed by the precious metal, or by the precious metal alloy, is at least 15 mm² and more preferably at least 30 mm². Even cylindrical electrode surfaces measuring more than 40 mm² can be implemented on the central electrode with functional reliability and the corresponding increase in the service life. For the opposing cylinder surface of the ground electrode, a size should be provided for, which, due to the larger diameter of the cylinder surface of the ground electrode, is accordingly larger than the cylinder surface formed at the central electrode from a precious metal or a precious metal alloy. The heights of the cylinder surfaces of the two electrodes are advantageously equal or approximately equal.

Initial tests have been successful in approximately doubling the service life of pre-chamber spark plugs of the type mentioned above using the invention.

The roughness of the mutually opposing cylinder surfaces is preferably kept small and limited to a maximum of 1.6 μm. This also provides a contribution to extending the service life.

In order to achieve the accuracy desired according to the invention, the central electrode is ground at least in the region of the cylinder surface made of precious metal or of a precious metal alloy. The corresponding cylinder surface, located opposite of the central electrode, of the ground electrode is preferably formed by a section cut from a drawn tube.

Advantageously, the central electrode and the ground electrode are provided with platinum or iridium, or with a platinum alloy or an iridium alloy, and particularly with a platinum-based alloy or with an iridium-based alloy.

The annular gap between the two cylinder surfaces of the central electrode and ground electrode formed by a precious metal, or a precious metal alloy, is preferably 0.25 mm to 0.35 mm.

The diameter of the central electrode may be larger than in the prior art, namely 2 mm to 8 mm, where the central electrode is provided with a precious metal tip or with a precious metal alloy tip. The inside diameter of the annular ground electrode is correspondingly larger.

### BRIEF DESCRIPTION OF THE DRAWINGS

Two embodiments of the invention are illustrated schematically in the attached drawings. Identical or corresponding parts are denoted with the same reference numerals in the two embodiments.

FIG. 1 shows a longitudinal section of a front section of a spark plug,

FIG. 2 shows a front view of the spark plug from FIG. 1, and

FIG. 3 shows a second embodiment of a spark plug according to the invention in a sectional view according to FIG. 1.

### DETAILED DESCRIPTION

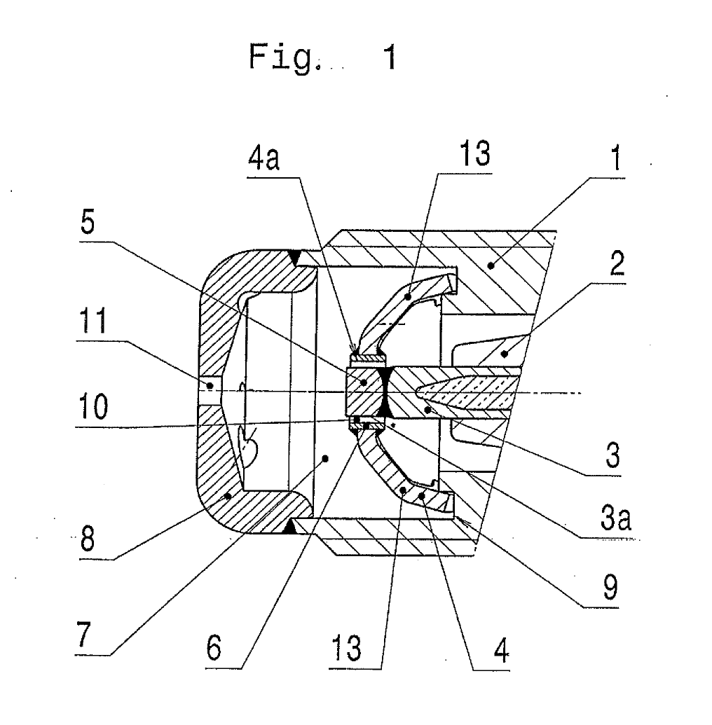

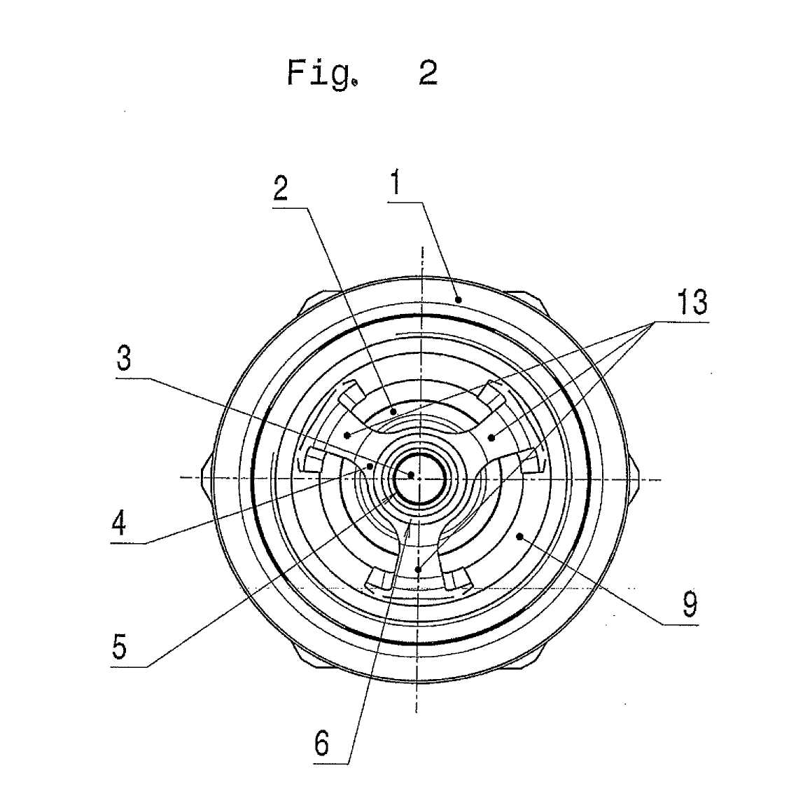

FIGS. 1 and 2 show a spark plug according to the invention, which substantially comprises a metallic body 1, a ceramic insulator 2, a central electrode 3, an ground electrode 4, and a cap 8. The cap 8 is connected to the metallic body 1 by a weld and, together with the same, forms an ante-chamber 7, in which the central electrode 3 and the ground electrode 4 are disposed. The end of the central electrode 3 is provided with a cylindrical precious metal piece 5, in particular by welding. The ground electrode 4 has an annular design and is lined with a cylindrical sleeve 6 made of precious metal or a precious metal alloy. The ground electrode 4, together with the cylindrical precious metal piece 5 of the central electrode 3, forms an annular ignition gap 10, in which the ignition sparks can spark over.

The cylindrical lateral surfaces 3a and 4a of the central electrode 3 and of the ground electrode 4 are produced with high accuracy and are coaxially disposed with high accuracy.

The ground electrode 4 is shown in a top view in FIG. 2; it is rigidly connected by way of three legs 13, which are disposed in a star shape and have an arcuate course, to the metallic body 1 of the spark plug, in that the three legs 13 are accommodated in an annular groove 9 at the front edge of the metallic body 1 and welded to the body 1.

The spark gap of the spark plug is formed by the cylindrical lateral surface 3a of the precious metal piece 5 of the central electrode 3 and by the inner cylindrical surface 4a of the precious metal sleeve 6 of the ground electrode 4. The cylindrical lateral surface 3a of the precious metal piece 5 of the central electrode 3 is at least 15 mm². The opposing precious metal sleeve 6 of the ground electrode 4 has a cylindrical inner surface of at least 17 mm². Both surfaces are available for the burn-off.

In the direction of the central electrode 3, the cap 8 comprises a borehole 11, through which an ignitable gas-air mixture is introduced in the ante-chamber 7 during a compression stroke of an internal combustion engine, where it is ignited by way of an ignition spark.

The configuration of the ground electrode 4 with the three legs 13 thereof ensures that the annular ignition gap 10 between the central electrode 3 and the ground electrode 4 is easily accessible. Once the mixture in the ante-chamber 7 has been ignited, the flame is thrown through the borehole 11 out of the ante-chamber 7 into the main combustion chamber of the internal combustion engine as a result of the combustion pressure and ignites the fuel-air mixture present there.

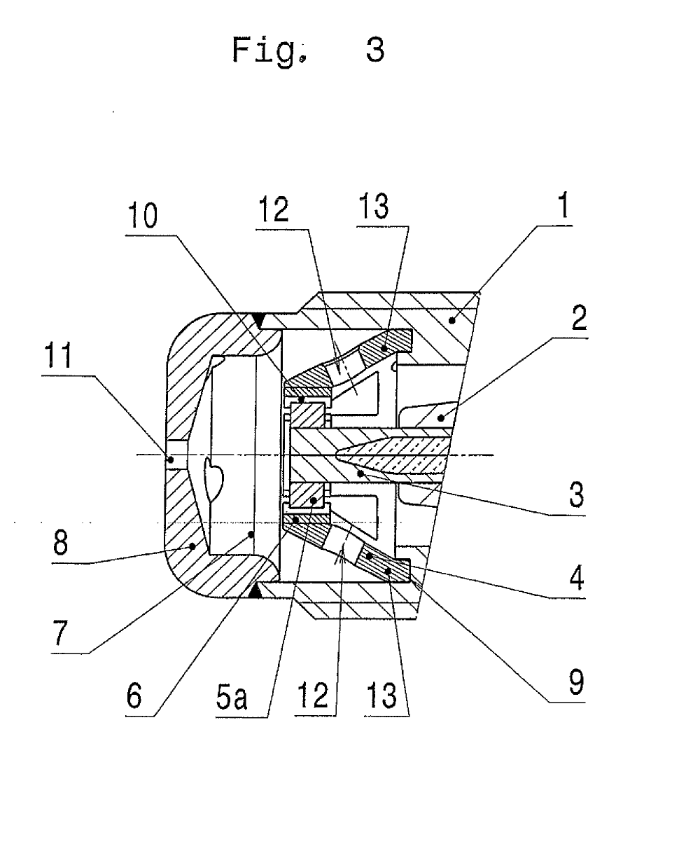

The embodiment illustrated in FIG. 3 differs from the embodiment shown in FIGS. 1 and 2 in that the central electrode 3 has a mushroom shape, wherein a ring 5a made of a precious metal or a precious metal alloy is pushed onto the end of the central electrode 3 that is otherwise made of a base metal and welded thereto. In this way, a larger electrode surface is produced, which according to the invention results in a longer service life because more electrode material is available for burn-off. A circulating borehole, which promotes the flow of the gas-air mixture around the central electrode 3, is provided in each leg 13 of the ground electrode 4.

Using the design shown in FIG. 3, electrode surfaces made of precious metal or made of a precious metal alloy can be achieved, which have a size of 40 mm² or more and which are available for the burn-off under the action of the ignition sparks.

### LIST OF REFERENCE NUMERALS

1 body
2 insulator
3 central electrode
3a cylindrical lateral surface
4 ground electrode
4a cylindrical lateral surface
5 precious metal piece
5a ring
6 precious metal sleeve
7 ante-chamber
8 cap
9 annular gap
10 Ignition gap
11 borehole, opening
12 circulating borehole
13 three legs

What is claimed is:

1. A spark plug for a gas-fired internal combustion engine, the spark plug comprising:
a metallic body,
an insulator fastened in the body,
a central electrode, leading through the insulator and having a precious metal or a precious metal alloy end protruding over the insulator;
an annular ground electrode, fastened to the body and surrounding the end of the central electrode, the ground electrode having a precious metal or precious metal alloy inside facing the central electrode, mutually facing surfaces of the central electrode and ground electrode being coaxially disposed cylinder surfaces; and
a cap, attached to the body for shielding the central electrode and the ground electrode upon installation of the spark plug into a combustion chamber of the internal combustion engine and together with the body of the spark plug, forming an ante-chamber for receiving the central electrode and the ground electrode, the cap having at least one opening, for enabling a gas exchange between the ante-chamber and a space outside of the ante-chamber, wherein a deviation of the coaxially disposed cylinder surfaces from an ideal cylinder geometry is less than +−20 μm, and a deviation of the positions of the axes of the coaxially disposed cylinder surfaces from an ideal coaxial positions is less than +−50 μm.

2. The spark plug according to claim 1, wherein a deviation of the width of an annular gap, measured in the radial direction, between the mutually opposing cylinder surfaces from a predetermined clearance is less than +−75 μm.

3. The spark plug according to claim 1, wherein a roughness of the mutually opposing cylinder surfaces of the central electrode and the ground electrode is no more than 1.6 μm.

4. The spark plug according to claim 1, wherein the cylinder surface configured on the central electrode is ground.

5. The spark plug according to claim 1, wherein the central electrode and the ground electrode are provided with platinum or iridium, or with a platinum alloy or with an iridium alloy.

6. The spark plug according to claim 1, wherein the annular gap between the two cylinder surfaces of the central electrode and the ground electrode is 0.2 mm to 0.5 mm.

7. The spark plug according to claim 1, wherein the diameter of the central electrode is 2 mm to 8 mm at a location, where it is provided with a precious metal or with a precious metal alloy.

8. The spark plug according to claim 1, wherein the size of the cylinder surface of the central electrode formed by the precious metal, or by the precious metal alloy, is at least 15 mm².

9. The spark plug according to claim 1, wherein the size of the cylinder surface of the central electrode formed by the precious metal, or by the precious metal alloy, is at least 30 mm².

10. The spark plug according to claim 1, wherein the size of the cylinder surface of the central electrode formed by the precious metal, or by the precious metal alloy, is at least 40 mm².

11. The spark plug according to claim 1, wherein a deviation of the width of an annular gap, measured in the radial direction, between the mutually opposing cylinder surfaces from a predetermined clearance is less than +−75 μm, and that a roughness of the mutually opposing cylinder surfaces of the central electrode and the ground electrode is no more than 1.6 μm.

12. The spark plug according to claim 1 wherein the central electrode and the ground electrode are tipped with a platinum-based alloy or with an iridium-based alloy

13. The spark plug according to claim 1 wherein the annular gap between the two cylinder surfaces of the central electrode and the ground electrode is 0,25 mm to 0,35 mm.
